(19) United States
(12) Patent Application Publication
(10) Pub. No.: US 2008/0032587 A1
(43) Pub. Date: Feb. 7, 2008

(54) GREETING CARD MOTION SYSTEM WITH MODULAR DESIGN

(75) Inventors: Doug L. Krivanek, Lenexa, KS (US); Robert W. Ferron, Kansas City, MO (US)

Correspondence Address: SHOOK, HARDY & BACON LLP;INTELLECTUAL PROPERTY DEPARTMENT, 2555 GRAND BLVD, KANSAS CITY, MO, 64108-2613, US

(73) Assignee: HALLMARK CARDS, INCORPORATED, KANSAS CITY, MO (US)

(21) Appl. No.: 11/833,868

(22) Filed: Aug. 3, 2007

Related U.S. Application Data
(60) Provisional application No. 60/821,688, filed on Aug. 7, 2006.

(51) Int. Cl. A63H 13/00; A63H 31/00; G09F 19/08

(52) U.S. Cl. 446/149; 40/421

(57) ABSTRACT

A modular motion device capable of incorporated into a greeting card has a packaging structure, a module drive mechanism and one or more visual elements capable of being set in motion by a user's interaction with the drive mechanism. The module drive mechanism includes a plurality of motion components, such as gears and pivot hubs. The motion components are activated in a first embodiment via manual rotation of a drive gear, in a second embodiment via manual rotation of a crank arm, and in a third embodiment via a motor.

### CROSS-REFERENCE TO RELATED APPLICATIONS

This application, having attorney docket number HALC.130460, claims the benefit of and priority to commonly owned U.S. Provisional Application Ser. No. 60/821,688, filed Aug. 7, 2006, which is hereby incorporated by reference in its entirety.

### STATEMENT REGARDING FEDERALLY SPONSORED RESEARCH OR DEVELOPMENT

Not applicable.

### BACKGROUND

The present invention is related to amusement devices, and more particularly, may be embodied as a greeting card product utilizing motion as a primary form of attraction.

Over the years, designers have utilized a wide variety of features to make greeting cards and related gift items more attractive and desirable to consumers. In addition to the use of various colors, pictures, designs and phrases, cards have also been designed with selectively moveable portions in an effort to draw attention to the card. A popular means for incorporating some form of motion into a greeting card is to employ paper mechanics technology with the moving items being located inside the card. The particular arrangement of folds in the paper inside the card make it such that the motion is generally caused by the opening and closing of the card, creating what is commonly referred to as a “pop-up” effect. While paper mechanics technology is well known and can provide for various types of movement, this method of imparting movement in the card is limited to the interior of a card and requires opening and closing of the card for activation which can partially obscure the moving objects. Therefore, it is desirable to provide a different method of imparting movement to objects on a card which are not limited by the drawbacks of the prior art.

### SUMMARY

A modular design greeting card motion device is disclosed for providing an animated gift product. The modular design allows for integration of reconfigurable motion mechanisms into a greeting card, enabling a wide variety of animation effects to be created for amusement of the product recipient. Furthermore, the modular design provides a compact product for ease of handling by the user.

In one aspect, the system takes the form of an amusement device, or animated greeting card assembly, including a packaging structure, a module drive mechanism and one or more visual elements set in motion by the user's interaction with the drive mechanism. The packaging structure includes a cover panel, and optionally a bottom panel, for concealing the drive mechanism. The module drive mechanism is formed of a base tray and a cap, with a plurality of motion components disposed therebetween and operatively supported on the base tray. The visual elements are interconnected with the motion components through openings in the packaging cover panel and the drive mechanism cap, such that the visual elements are positioned adjacent to the cover panel and viewable by the user. Upon the user providing manual input to the module drive mechanism, the motion components initiate animation of the visual elements. The animation may encompass a variety of movement schemes, including a pivotable action, a translational or path-tracing action, a circular or non-circular looping action, and other simple and complex motion patterns.

In another aspect, the motion components of the module drive mechanism may include one or more drive gears and output gears. The drive gears may be positioned at multiple locations on the mechanism base tray, depending on the desired orientation of the greeting card and where manual input is to be received on the system. The output gears may connect directly to the visual elements, or may transfer rotational motion to certain “action” components that convert the rotation into other animation patterns (e.g., a reciprocating pivot, translation, looping). A pulley system may be employed to directly receive the user input and transfer the applied force to the drive gears. Additionally, because the drive mechanism tray may be formed with a plurality of bearing regions for supporting motion components, such components are easily reconfigured on the tray and coupled to other action components to create new animation patterns.

Additional advantages and features of the invention will be set forth in part in a description which follows, and in part will become apparent to those skilled in the art upon examination of the following, or may be learned by practice of the invention.

### BRIEF DESCRIPTION OF SEVERAL VIEWS OF THE DRAWINGS

The present invention is described in detail below with reference to the attached drawing figures, wherein:

FIG. 1 is a perspective view of a base tray of a module drive mechanism for integration with a greeting card, in accordance with one embodiment of the present invention;

FIG. 2 is a perspective view of a build up of the module drive mechanism, with a sample set of gears positioned on the base tray of FIG. 1;

FIG. 3 is a perspective view of a further build up of the module drive mechanism, with a mid-level cap placed over the subassembly of FIG. 2;

FIG. 4 is a perspective view of a still further build up of the module drive mechanism, with a sample of various action components coupled with the set of gears and placed over the subassembly of FIG. 3;

FIG. 5 is a perspective view of a further build up of the module drive mechanism, with a top cap placed over the subassembly of FIG. 4;

FIG. 6 is a back perspective view of an embodiment of the module drive mechanism integrated with a greeting card, depicting a user providing input to a drive gear to initiate motion activity;

FIG. 7 is a perspective view of another embodiment of a module drive mechanism build up integrated with a greeting card, with a sample set of gears positioned on a base tray;

FIG. 8 is a perspective view of a build up of the module drive mechanism, with a sample of various action components coupled with the set of gears and placed over the subassembly of FIG. 7;

FIG. 9 is a perspective view of a further build up of the module drive mechanism, with a cap placed over the subassembly of FIG. 8;

FIGS. 10A and 10B show front views of an animated greeting card assembly having visual elements representing a circus type scene, with various gears and action components driving pivotable movement of the visual elements; and

FIGS. 11A and 11B show front views of another animated greeting card assembly having visual elements representing a rodeo type scene, with various gears and action components driving linear, translational movement of the visual elements.

### DETAILED DESCRIPTION

Various embodiments of the modular design greeting card motion device are shown throughout the figures. As explained more fully herein, the motion device employs a module drive mechanism, or “module”, to generate animation of certain visual elements in response to user initiated input. The module may be integrated into a modified version of a traditional greeting card or similar structure. The visual elements being animated, along with other indicia positioned on the packaging forming the greeting card, provide a theme for the amusement of the user. Additionally, certain motion components of the module are configured for interchangeability and repositioning within the module by the greeting card designer, enabling new animation patterns to be readily generated. The compact nature of the module facilitates the integration of the module into other amusement devices besides greeting cards, such as books and other items.

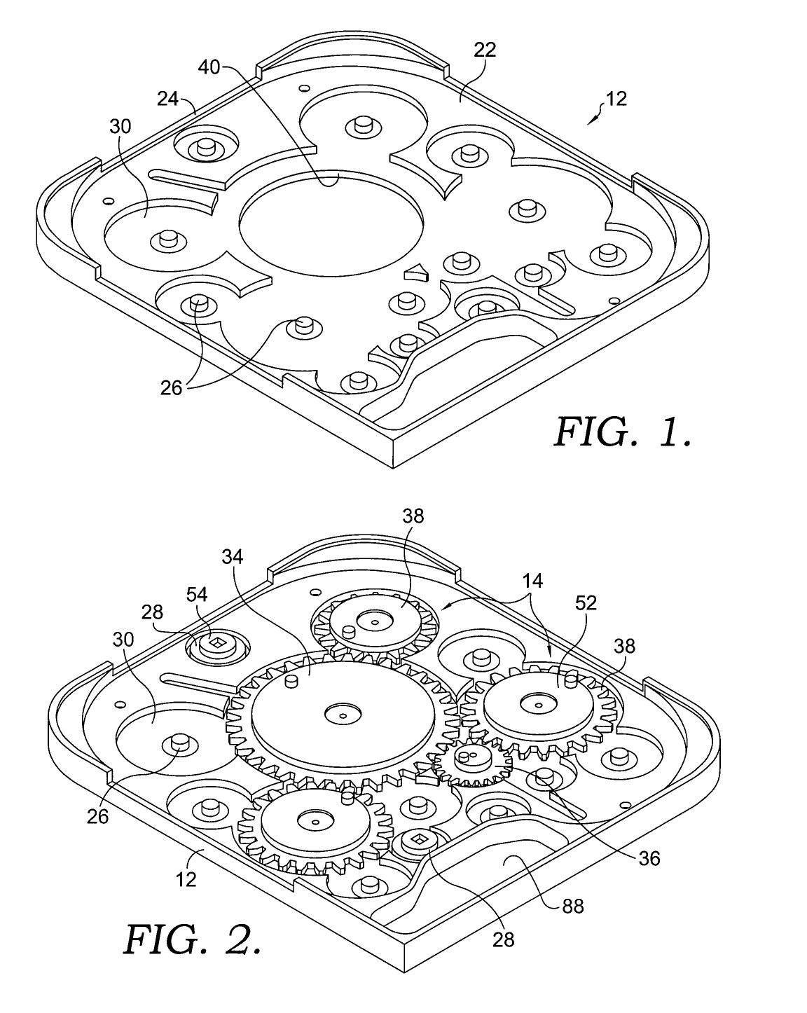

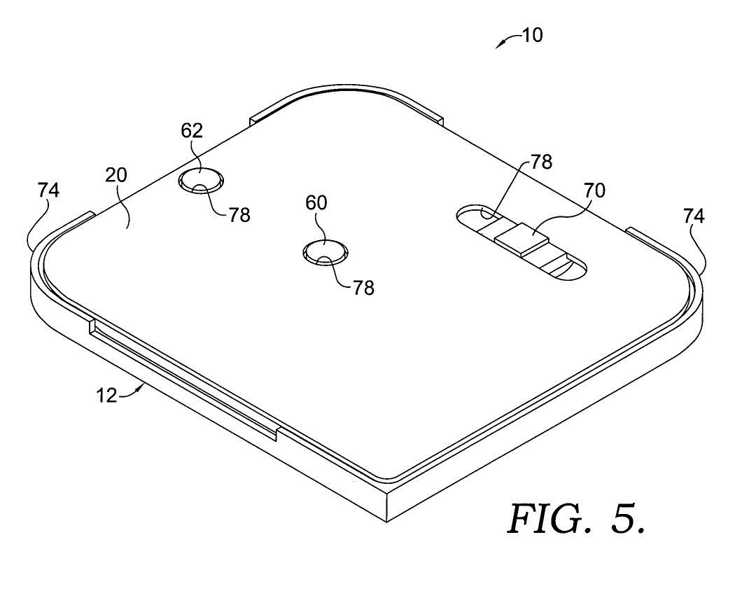

Referring now to the drawings in more detail and initially to FIGS. 1-5, reference numeral 10 designates one embodiment of a module drive mechanism for a greeting card assembly. The module 10 includes, in built-up layers, a base tray 12, a set of gears 14 for generating motion responsive to use input, a mid-level cap 16, a set of action components 18 coupled with the gears 14 to generate a specific movement output based on the gear motion, and a top cap 20 encasing the gears 14, the mid-level cap 16 and the action components 18 between the base tray 12 and the top cap 20. The gears 14 and action components 18 are also generically referred to herein as “motion components”. The structural elements forming the module 10 may be formed out of molded plastics and other composites, for ease of mass production.

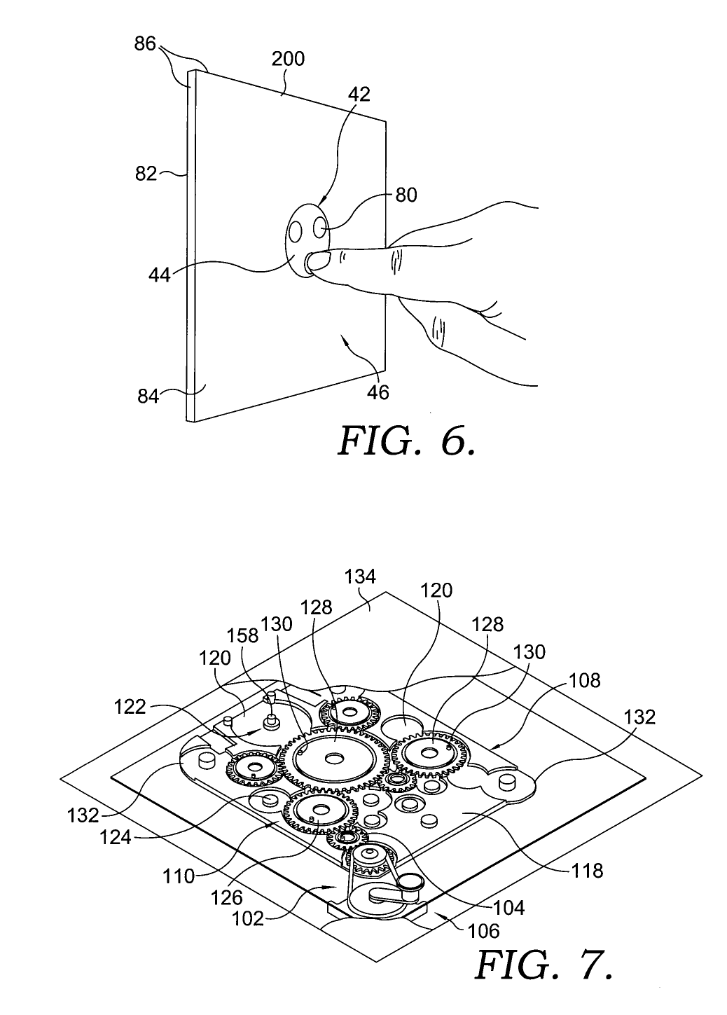

The base tray 12 includes a bottom floor 22, a perimeter upturned flange wall 24 and a plurality of posts 26 extending upwardly from the floor 22. The posts 26 serve as locations for the axial mounting of the set of gears 14 and pivot hubs 28 that also perform the function of “motion components”. The bottom floor 22 is also formed with a plurality of recesses 30 that serve as bearing regions for operatively supporting the gears 14 and pivot hubs 28 during rotation on the posts 26, as best seen in FIG. 2. The set of gears 14 include a drive gear 34, one or more transfer gears 36, and one or more output gears 38 coupled with the action components 18. In this embodiment, the base tray bottom floor 22 includes a circular through opening 40 sized to receive an axially-aligned, downwardly oriented cylindrical extension 42 of the drive gear 34, such that a lower surface 44 of the cylindrical extension 42 is accessible from a rear side 46 of the module 10, as explained in further detain herein with respect to FIG. 6.

Throughout the various embodiments of the module 10 described herein, the term “drive gear” refers to a gear receiving either a direct force input from a user, or a force from another input object with which the user interacts to provide input. The transfer gear 36 is configured to transmit by rotational gear engagement a force from a drive gear 34 to an output gear 38, either directly or through rotational interaction with other transfer gears 36. Each of the gears 14 may have upwardly extending posts 48 spaced from and parallel to the axis of the respective gear. Such posts 48 are particularly utilized by the output gears 38 to engage with the action components 18 and drive the movement of such components 18. Additionally, as can be understood, gears 14 and pivot hubs 28 are not necessarily located on each open post 26 and recess 30. The particular gears 14 and pivot hubs 28 selected are a matter of design choice based on the need to create a specific movement pattern for the visual elements being animated by either the action components 18 or directly by the output gears 38, as explained in further detail herein. It is preferable to form the base tray 12 with a number of posts 26 and recesses 30 sufficient for a module designer to generate many possible combinations of movements depending on the particular motion components implemented in the module 10. Furthermore, a particular gear 14, such as drive gear 34, may also perform the function of another type of gear, such as transfer gear 36 or output gear 38, depending on the particular configuration of the gears 14 selected to produce a desired output motion.

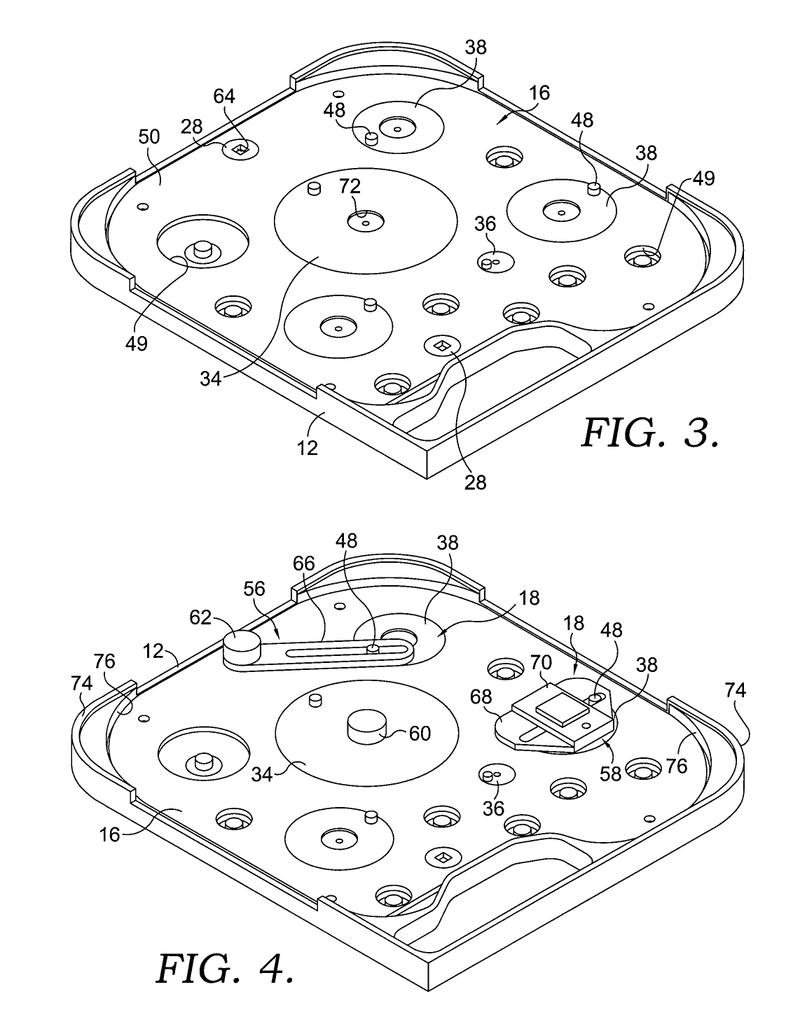

The mid-level cap 16 functions to retain the gears 14 and pivot hubs 28 on the respective posts 26 and within the respective recesses 30 of the bottom floor 22 of the base tray 12. The cap 16 has a number of through holes 49 aligned with the recesses 30. The through holes 49 allow the gears 14 and pivot hubs 28 to at least partially extend through the cap 16, aiding in retention of the gears and hubs while also exposing the posts 48 for engagement with the action components. While a standard cap 16 would be used, the cap 16 could be customized regarding the number and location of through holes 49 depending on the number and location of gears 14 and pivot hubs 28 used in a specific embodiment. Preferably, the mid-level cap 16 has a thickness necessary for a top surface 50 of the cap 16 to be flush with upwardly oriented cylindrical extensions 52 and 54 of the gears 14 and pivot hubs 28, respectively, as shown in FIG. 3.

The action components 18 may then be coupled with the output gears 38 and pivot hubs 28, as shown in FIG. 4. For instance, motions such as spinning (e.g., point spinning in a zero turn radius), swiveling (e.g., reciprocating pivot motion), swinging (e.g., reciprocating pivot motion with a linear extension) and sliding (e.g., in a looped configuration or a non-looped, translation motion) are enabled by the action components 18 moving in response to the force input applied from the output gears 38. In the exemplary arrangement shown in FIG. 4, the action components 18 include a swivel bar 56, a slide block 58, and a cylindrical spin block 60. The swivel bar 56 is formed by a hub 62 mating with a recess 64 of the pivot hub 28 and a slotted finger 66 extending radially from the hub 62 for receiving one of the gear posts 48 therein. The slide block 58 likewise includes a slotted base 68 (for receiving another gear post 48), as well as an upper member 70. The cylindrical spin block 60 is sized to be seated within an axial recess 72 in the cylindrical extension 52 of the drive gear 34.

Once the desired action components 18 are in place, the top cap 20 is secured over the mid-level cap 16 and the action components 18. The flange wall 24 of the base tray 12 includes corner retainers 74 for securing the top cap 20 on the remaining build-up layers of the module 10. The top cap 20 may be secured with the base tray corner retainers 74 by a variety of methods, such as by sizing the perimeter of the cap 20 to friction fit with the inside walls 76 of the corner retainers 74 or by utilizing an adhesive to secure the cap 20 perimeter to the corner retainers 74. The particular top cap 20 selected should have a number of through holes 78 positioned for alignment with the respective action components 18, enabling the desired visual elements for the greeting card design to be coupled therewith and set in motion by user input on the drive gear 34.

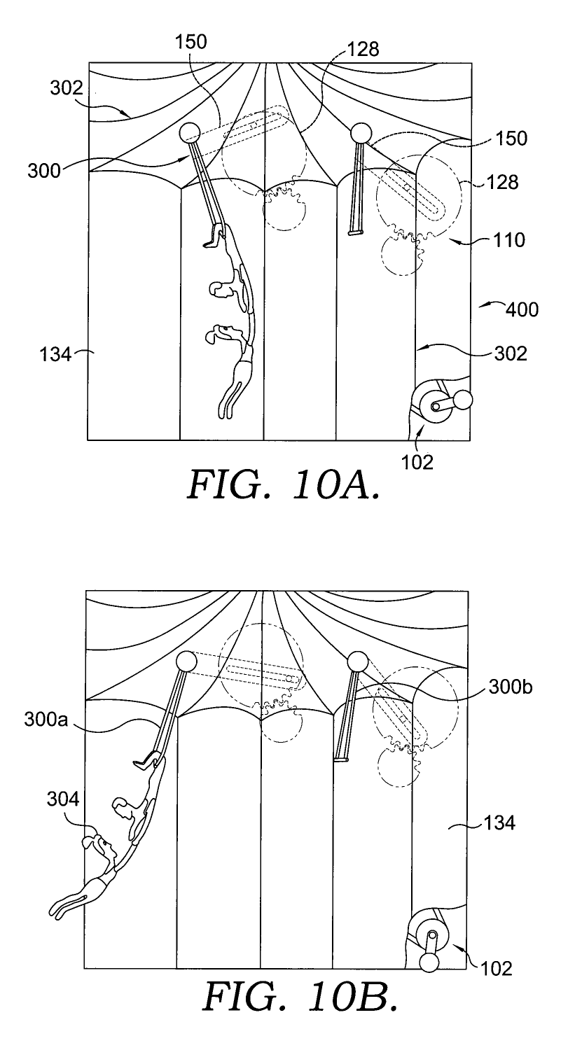

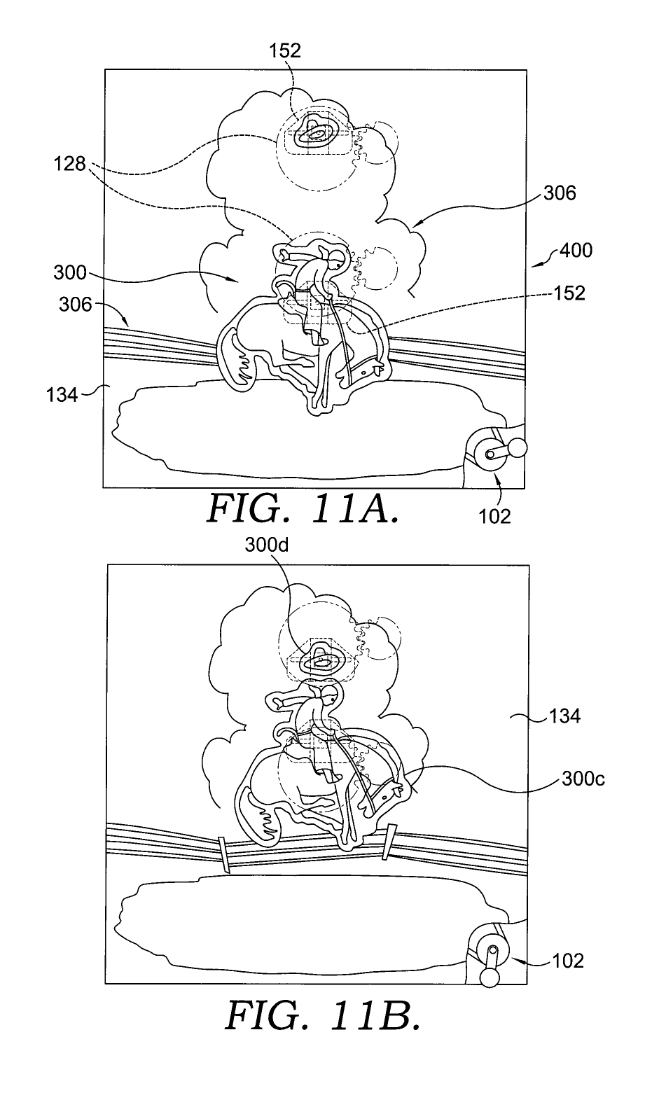

The module 10 is depicted in FIG. 6 as being integrated into a greeting card product 200 with a cover panel 82 and bottom panel 84. In the particular configuration of the greeting card product 200 depicted in FIG. 6, the drive gear cylindrical extension 42 extends through a central opening in the bottom panel 84 to enable a user to provide input on the drive gear 34. The cover panel 82 and the bottom panel 84 may be formed from a single piece of card stock folded to cover the front side (i.e., top cap 20) and the rear side 46 of the module 10, as well as a common perimeter 86 created by the built-up thickness of the module 10. In such an arrangement, the cover panel 82 and bottom panel 84 combine to form a pocket within which the module 10 is disposed. The cover panel 82 is adhered to the top cap 20, the bottom panel 84 is adhered to the underside of the base tray 12, and the common perimeter 86 is adhered to an outwardly facing portion of the base tray flange wall 24. Alternatively, the cover panel 82 may be a separate element covering the top cap 20, and the bottom panel 84 may be an optional element for covering the module rear side 46. Additionally, in another embodiment, a rear panel (not shown) could be provided. The rear panel could be joined with the bottom panel 84 along a common edge to provide a user viewable and accessible interior of the greeting card product 200 where text is provided, similar to a standard greeting card without motion elements. In this embodiment, the side of the bottom panel 84 that is viewable in FIG. 6 would be an interior left side of the greeting card. Particular exemplary visual elements 300 coupled with certain motion components of an exemplary greeting card product are shown in FIGS. 10A-11B, including a trapeze with swinging movements, and a horse rider with linear, sliding movements, as explained in more detail herein.

In use, a person (e.g., the greeting card product recipient) engages a set of dimples 80 on the lower surface 44 of the drive gear cylindrical extension 42 to effect rotation of the drive gear 34. With continued reference to FIGS. 1-5, the exemplary gear arrangement for the module 10 shown provides for the drive gear 34 directly mating with the particular output gear 38 coupled with the swivel bar 56, and indirectly engaging with the output gear 38 coupled with the slide block 58 through the transfer gear 36. In this way, the drive gear 34 rotation drives the swiveling motion of the swivel bar hub 62 via the slotted finger 66 oscillating on the gear post 48 orbiting around the axis of the respective output gear 38 in a circular travel path. The drive gear 34 rotation also drives the linear back-and-forth motion of the slide block upper member 70 via the slide block slotted base 68 oscillating on the respective output gear post 48 orbiting around the axis of the respective output gear 38. The elongate configuration of the particular top cap through hole 78 through which the slide block upper member 70 extends guides the upper member 70 along linear movement. Still further, the rotation of the drive gear 34 rotates the cylindrical spin block 60 in place to induce a spinning motion. The movements of the action components 18 and corresponding animation of the visual elements may be either coordinated with one another for visual appeal, or alternatively may lack coordination, but in any case movement of all components 18 occurs simultaneously.

As an alternative to the arrangement shown where a user physically drives the motion of the module 10 through drive gear 34, a small electric or spring wound motor (not shown) may be coupled with one of the gears 14 or pivot hubs 28 to drive the movement of the “motion components”. A battery or other power supply (not shown) may be stored within a compartment 88 formed in the base tray 12.

Turning to FIGS. 7-11B, another embodiment of a module drive mechanism 100 for a greeting card assembly is depicted. The module 100 employs many of the features of the embodiment of the module 10 shown in FIGS. 1-5, including the utilization of motion components sandwiched between a base tray and a top cap to effect animation of visual elements coupled therewith. However, instead of implementing a drive gear design that relies on a person providing a direct force input on the drive gear portion exposed through a greeting card panel, a user input mechanism 102 is mechanically coupled with a drive gear 104. Although not limited to any particular location on the overall module 100, in one practical embodiment shown in FIGS. 7-9, the user input mechanism 102 is located near a perimeter 106 of the module 100 to reduce the interference with the movements of the motion components (as well as the animation of the visual elements 300 shown in FIGS. 10A-11B).

The module 100 is formed by a built-up configuration similar to module 10 of FIGS. 1-5, and preferably includes a base tray 108, a set of gears 110, a set of action components 112, and a top cap 114 . Additionally, a bottom plate 116 may be provided as a support structure beneath the base tray 108 and also serve as a mounting structure for the user input mechanism 102. The top cap 114 may likewise serve as a structure to which the user input mechanism 102 is mounted.

Similar to the base tray 12 of module 10, the base tray 108 includes a bottom floor 118, a plurality of recesses 120 formed into the bottom floor 118 to serve as bearing regions operatively supporting particular gears 110 and pivot hubs 122 in rotation, and a plurality of posts 124 extending upwardly from the bottom floor 118 in the bearing regions and with which the gears 110 and hubs 122 may be axially mounted. The gears 110 include the drive gear 104, which receives a rotation inducing force from the user input mechanism 102, one or more transfer gears 126 and one or more output gears 128 coupled with the action components 112. Selected gears 110 (i.e., gears that are likely to be utilized in the module 100 as output gears 128, depending on the configuration selected by the module designer) have upwardly extending posts 130 spaced from and parallel to the axis of the respective gear.

As with the configuration of the module 10 shown in FIGS. 1-5, the base tray 108 of module 100 is preferably formed with a sufficient number of recesses 120 and posts 124 for a module designer to generate many possible combinations of movements depending on the particular motion components implemented in the module 100. Additionally, to afford the module designer greater flexibility in positioning a user input mechanism 102, the base tray 108 preferably has a recess 120 and corresponding post 124 at each outside perimeter corner 132 thereof. This enables the portion of the module 100 build-up above the bottom plate 116 to be rotated to a variety of different orientations with respect to the overlying or surrounding greeting card packaging structure, such as cover panel 134, while maintaining a simple mechanical coupling arrangement between the input mechanism 102 and one of the drive gears 124. Differing orientations of the base tray 108 in particular enable the output gears 128 and the corresponding action components 112 to present animations of the visual elements 300 to the user in different ways.

One example of a user input mechanism 102 is a pulley system. The pulley system 102 includes a driving pulley wheel 136, a crank arm 138 rigidly connected to the axis of the pulley wheel 136 for imparting rotation thereof, and a flexible band 140 for transferring the motion of the pulley wheel 136 to an extension 142 of the drive gear 104. The pulley wheel 136 may be rotatably mounted to a mounting bracket 144 on an underside of the wheel 136, and to the top cap 114 on an upper side of the wheel 136, via an axial pin (not shown) to stabilize the wheel 104 during rotation. The drive gear extension 142 is generally an axially-aligned, upwardly oriented cylinder with a circumferential groove 146 for receiving and frictionally engaging with the band 140. Likewise, the pulley wheel 136 has a circumferential groove 148 frictionally engaging the band 140. The flexible band 140 may be formed of rubber or other suitable materials. It should be also understood that other alternative user input mechanisms may be substituted for the pulley system 102 of the module 100, such as additional gears, linkage arrangements, levers, and other mechanical structures.

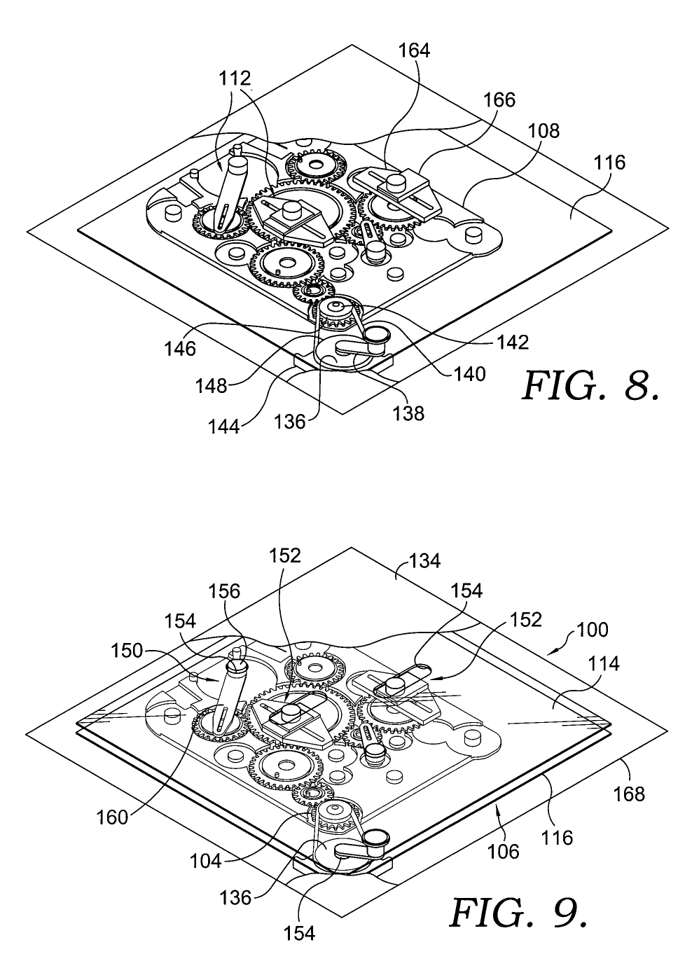

Upon the desired gears 110 and pivot hubs 122 being placed on the appropriate posts 124, the action components 112 are then set in place to create the desired movements to be translated into animation by the attached visual elements 300. With the exemplary arrangement shown in FIGS. 8 and 9, the action components include a swivel bar 150 and a pair of slide blocks 152, which may possess the same configuration as the swivel bar 56 and slide block 58 of the module 10 depicted in FIGS. 1-5. The top cap 114 is then secured over the action components 112 and the remainder of the motion components mounted on the base tray 108. The top cap 114 has a series of through holes 154 aligned with the respective action components 112, to allow the visual elements 300 to connect to the action components 112 through the top cap 114. Additionally, in a preferred arrangement, the top cap 114 has another through hole 154 at the axis of the pulley wheel 136. This enables the pulley system 102 (minus the crank arm 138) to first be installed on the module 100, then the top cap 114 secured in place, and then the crank arm 138 secured to the pulley wheel 136 (e.g., by a fastener) through the through hole 154. The top cap 114 may be secured to any of the underlying layers of the module 100 (e.g., the base tray 108 or bottom plate 116) by a variety of techniques, such as by applying adhesives to the underside of the cap 114. The important parameter is to ensure that the top cap 114 does not interfere with the movement of the motion components utilized in the module 100. Still further, the top cap 114 may be formed of transparent or translucent materials, as shown in FIG. 9. It should be understood that, as with the module 10 of FIGS. 1-5, the structural elements forming the module 100 may be formed out of molded plastics and other composites.

In use, a person applies an input force on the crank arm 138 to induce movement of the action components 112 and ultimately animation of the visual elements 300. The tension on the band 140 extending around the drive gear extension 142 and the pulley wheel 136 enables the rotation of the wheel 136 via the crank arm 138 to induce rotation of the drive gear 104 and corresponding movement of the motion components (i.e., gears 110, action components 112 and pivot hubs 122). The drive gear 104 transfers the rotational motion to the remaining gears 110, and the output gears 128 transfer the rotational motion via the posts 130 to swivel bar 150 and slide blocks 152. In particular, each swivel bar 150 has a hub 156 mating with an upwardly cylindrical extension 158 of the pivot hub 122 and a slotted finger 160 extending radially from hub 156 and configured to receive the post 130 of the respective output gear 128. The hub 156 undergoes a reciprocating pivot motion, or swivel, as the slotted finger 160 undergoes an oscillating action set in motion via the circular travel path of the output gear post 130. Likewise, each slide block 152 has a slotted base 164 configured to receive the post 130 of the respective output gear 128 and an upper member 166 extending from the base 164. The upper member 166

undergoes a linear back-and-forth motion due to both the circular travel of the post 130 received in the slotted base 164 causing oscillation of the slotted base 164, as well as the elongate configuration of the respective top cap through hole 154 through which the upper member 166 extends establishing a linear travel path.

As referenced above, the module 100 is preferably integrated into a greeting card product 400, or packaging structure, having the cover panel 134 and a bottom panel 168 disposed beneath the bottom plate 116. The greeting card product 400 may optionally have a rear panel (not shown) that cooperates with the bottom panel 168 to provide an interior of the card where a greeting may be placed. The packaging structure 400 may be formed from card stock in a similar configuration to the cover panel 82 and bottom panel 84 of module 10.

With particular reference to FIGS. 10A-11B, the positioning of certain exemplary visual elements 300 undergoing animation are shown with respect to the driving motion components. It should be understood that portions of the gears 110 shown in FIGS. 10A-11B (such as a number of circumscribing gear teeth) have been omitted for clarity of presentation. The swinging trapeze scene depicted in FIGS. 10A and 10B utilizes motion components of the module 100 along with a pair of swing-type visual elements 300a and 300b to create the desired animation. Various illustrations 302 or other indicia are also formed on the cover panel 134 of the greeting card product 400 in keeping with the circus theme. As the user turns the crank arm 138 of the pulley system 102, a pair of swivel bars 150 set in motion by the gears 110 cause the coordinated animation of the visual elements, such that the persons 304 formed on the visual elements appear to be preparing to move from one of the elements 300a to the other element 300b.

In a similar fashion, the horse riding scene depicted in FIGS. 11A and 11B utilizes module motion components along with a horse/rider combination visual element 300c and a rider hat visual element 300d for generating a particular animation pattern. The horse riding or rodeo theme is accentuated with various illustrations 306 formed on the cover panel 134. With the engagement of the pulley system 102 by the user, a pair of slide blocks 152 set in motion by gears 110 cause the coordinated linear up-and-down motion of the horse/rider element 300c and the hat element 300d, so that these elements move closer to and then away from one another. In this way, the rider appears to lose their hat as they move closer to the ground, only to return upwardly into the air to be in proximity to the hat. Alternately, rocking motion could be applied to the horse/rider element 300c to give the appearance the horse is bucking.

As can be appreciated, the various embodiments of the module drive mechanism and other elements forming a greeting card assembly can provide virtually endless combinations of movement for visual elements present on the front of the greeting card product. Other embodiments of and modifications to the invention are beneficial as well and are within the scope of the present invention. For example, the movement of the components can be used to produce mechanical sounds. This sound can be caused, for instance, by a protrusion on one of the motion components contacting a flexible arm. When the arm is released, it strikes a surface and causes a sound. Sound can also be created by having loose items enclosed in a moving component, such as small metal or plastic balls. When the component turns, the balls strike each other, creating sound. Sound can also be produced by clicking, ringing, stirring, and crinkle plastic.

The modular design of the greeting card assembly allows for interchangeability of moving parts, while maintaining a thin profile mechanism desired for greeting cards and the like. The manual user input also means that the user has control over the motion input, and thus, the motion output. The user can start and stop the motion, can reverse motion direction, and can change the speed of the motion. Still further, it should be understood that various other motion components may be implemented into the module drive mechanism to generate a vast array of animation possibilities. Examples of such motion components include worm and helical gears, multi-linkage assemblies, rack and pinion arrangements, and other known components.

From the foregoing it will be seen that this invention is one well adapted to attain all ends and objects hereinabove set forth together with the other advantages which are obvious and which are inherent to the structure. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. An amusement device, comprising:
a packaging structure formed by a cover panel having a top surface and a bottom surface, the top surface having at least one opening therethrough;
a module drive mechanism mounted to the packaging structure and oriented to face the packaging structure bottom surface, the mechanism including
a base tray,
a plurality of motion components operatively supported on the base tray,
a cap disposed over the base tray and at least substantially covering the plurality of motion components, the cap having at least one opening aligned with the at least one opening of the packaging structure top surface to enable a portion of the plurality of motion components to extend therethrough; and
at least one visual element supported by the portion of the plurality of motion components extending through the at least one opening of the cap and the at least one opening of the packaging structure top surface, wherein mechanical output of the plurality of motion components induces animation of the at least one visual element positioned adjacent to the packaging structure top surface.

2. The amusement device of claim 1, wherein the packaging structure further includes a bottom panel interconnected with the cover panel to define an interior space therebetween, and wherein the module drive mechanism is at least substantially located within the interior space of the packaging structure.

3. The amusement device of claim 1, wherein the plurality of motion components include a driving component adapted to receive a user input force, and wherein the base tray is adapted for direct mounting of the driving component at a plurality of positions on the base tray.

4. The amusement device of claim 1, wherein the plurality of motion components include a drive gear and at least one output gear rotatably mounted on the base tray, the drive gear being adapted to receive a user input force and induce corresponding rotation of the at least one output gear.

5. The amusement device of claim 4, further comprising a pulley system directly coupled to the drive gear and a crank arm extending from the pulley system for receiving the user input force to induce pulley system movement.

6. The amusement device of claim 4, wherein the portion of the plurality of motion components extending through the at least one opening of the cap and the at least one opening of the packaging structure top surface is directly coupled with the at least one output gear.

7. The amusement device of claim 6, wherein the portion of the plurality of motion components extending through the at least one opening of the cap and the at least one opening of the packaging structure top surface includes at least one mechanical structure operatively converting a rotational movement into at least one movement selected from the group consisting of a reciprocating pivotable action, a translational action and a noncircular looping action.

8. The amusement device of claim 1, further comprising indicia formed on the cover panel top surface, the indicia and the at least one visual element presenting a common visual theme.

9. A module drive mechanism for an amusement device, comprising:
a base tray formed with a plurality of bearing regions,
a plurality of motion components operatively supported within the plurality of bearing regions;
a cap disposed over the base tray and at least substantially covering the plurality of motion components, the cap having at least one opening; and
at least one visual element interconnected with a portion of the plurality of motion components through the at least one opening of the cap, wherein mechanical output of the plurality of motion components induces animation of the at least one visual element.

10. The mechanism of claim 9, wherein the plurality of motion components include a driving component adapted to receive a user input force, and wherein the plurality of bearing regions of the base tray are adapted for direct mounting of the driving component at a plurality of positions on the base tray.

11. The mechanism of claim 9, wherein the plurality of motion components include a drive gear and at least one output gear rotatably mounted on at least one of the bearing regions of the base tray, the drive gear being adapted to receive a user input force and induce corresponding rotation of the at least one output gear.

12. The mechanism of claim 11, further comprising a pulley system directly coupled to the drive gear and a crank arm extending from the pulley system for receiving the user input force to induce pulley system movement.

13. The mechanism of claim 11, wherein the plurality of motion components include at least one transfer gear rotatably mounted on at least one of the bearing regions of the base tray between the drive gear and the at least one output gear, the at least one transfer gear receiving the user input force from the drive gear and transferring said force to the at least one output gear.

14. The mechanism of claim 11, wherein the portion of the plurality of motion components interconnected with the at least one visual element include at least one mechanical structure operatively converting a rotational movement into at least one movement selected from the group consisting of a reciprocating pivotable action, a translational action and a noncircular looping action.

15. An animated greeting card assembly, comprising:
a cover panel having at least one opening therethrough, an exposed surface and a perimeter, the exposed surface having indicia formed thereon;
a bottom panel interconnected with the cover panel about the perimeter to define a pocket therebetween;
a module drive mechanism mounted within the pocket and oriented to face the cover panel, the mechanism including:
a base tray formed with a plurality of bearing regions,
a plurality of gears operatively supported within the plurality of bearing regions and adapted to receive a user input force, and
at least one mechanical component coupled with at least one of the plurality of gears to produce an output motion responsive to said user input force; and
at least one visual element interconnected with the at least one mechanical component through the at least one opening of the cover panel to position said at least one visual element adjacent to the cover panel exposed surface, wherein the output motion induces animation of the at least one visual element.

16. The assembly of claim 15, wherein the plurality of gears include a drive gear and at least one output gear rotatably mounted on at least one of the bearing regions of the base tray.

17. The assembly of claim 16, wherein the plurality of bearing regions of the base tray are adapted for direct mounting of the drive gear at a plurality of positions on the base tray.

18. The assembly of claim 16, further comprising a pulley system directly coupled to the drive gear and a crank arm extending from the pulley system for receiving the user input force to induce pulley system movement and thereby transfer the user input force to the drive gear.

19. The assembly of claim 16, wherein the at least one mechanical component is adapted to operatively convert a rotational movement into at least one movement selected from the group of a reciprocating pivotable action, a translational action and a noncircular looping action.

20. The assembly of claim 15, wherein the combination of the indicia on the cover panel exposed surface and the at least one visual element present a common visual theme.

21. The assembly of claim 15, further comprising a rear panel connected to the bottom panel along a fold line, wherein a first surface of the rear panel is movable toward and away from an outer surface of the bottom panel, whereby a user accessible greeting card interior is provided.
